(19) United States
(12) Patent Application Publication
(10) Pub. No.: US 2007/0100783 A1
(43) Pub. Date: May 3, 2007

(54) Method, system, and program for determining discrepancies between database management systems

(75) Inventors: Enzo Cialini, Mississauga (CA); Anthony Di Loreto, Markham (CA); David Richard Godwin, Whitby (CA)

Correspondence Address: SAMUEL A. KASSATLY LAW OFFICE, 20690 VIEW OAKS WAY, SAN JOSE, CA, 95120, US

(73) Assignee: International Business Machines Corporation, Armonk, NY (US)

(21) Appl. No.: 11/262,840

(22) Filed: Oct. 29, 2005

(51) Int. Cl. G06F 17/30

(52) U.S. Cl. 707/1

(57) ABSTRACT

A data processing system implemented method, a data processing system, and an article of manufacture determine discrepancies between a first database management system and a second database management system. The first database management system populates a first database and the second database management system populates a second database. The data processing system implemented method includes receiving a first query response, the received first query response generated by the first database management system querying the first database, receiving a second query response, the received second query response generated by the second database management system querying the second database, detecting discrepancies between the received first query response and the received second query response, and providing an indicator, the provided indicator indicating the detected discrepancies.

### FIELD OF THE INVENTION

The present invention relates to database management systems (DBMSs) in general. More particularly, the present invention relates to a data processing system implemented method, a data processing system, and an article of manufacture for determining discrepancies between DBMSs.

### BACKGROUND

Determining accuracy and reliability of a DBMS can be a complex problem. Attempting to determine the accuracy and reliability of DBMSs manufactured by different vendors may be an even more complicated problem. Known approaches for determining DBMS performance may involve creating an independent SQL interpreter for all valid SQL statements executed by the DBMS. This may become an onerous task since SQL statements may be very complex, and results derived to date using this approach have been unsatisfactory in terms of time and effort taken to construct SQL interpreters. Therefore, a solution is desired for determining DBMS accuracy and reliability by determining discrepancies between DBMSs.

### SUMMARY

In a first aspect of the present invention, there is provided a data processing system implemented method of directing a data processing system to determine discrepancies between a first database management system and a second database management system, the first database management system populating a first database and the second database management system populating a second database, the data processing system implemented method including receiving a first query response, the received first query response generated by the first database management system querying the first database, receiving a second query response, the received second query response generated by the second database management system querying the second database, detecting discrepancies between the received first query response and the received second query response, and providing an indicator, the provided indicator indicating the detected discrepancies.

In a second aspect of the present invention, there is provided a data processing system for determining discrepancies between a first database management system and a second database management system, the first database management system populating a first database and the second database management system populating a second database, the data processing system including a receiving module for receiving a first query response, the received first query response generated by the first database management system querying the first database, a reception module for receiving a second query response, the received second query response generated by the second database management system querying the second database, a detecting module for detecting discrepancies between the first query response and the second query response; and a providing module for providing an indicator, the provided indicator indicating the detected discrepancies.

In a third aspect of the present invention, there is provided an article of manufacture for directing a data processing system to determine discrepancies between a first database management system and a second database management system, the first database management system populating a first database and the second database management system populating a second database, the article of manufacture including a program usable medium embodying one or more instructions executable by the data processing system, the one or more instructions including data processing system executable instructions for receiving a first query response, the received first query response generated by the first database management system querying the first database, data processing system executable instructions for receiving a second query response, the received second query response generated by the second database management system querying the second database, data processing system executable instructions for detecting discrepancies between the received first query response and the received second query response, and data processing system executable instructions for providing an indicator, the provided indicator indicating the detected discrepancies.

### DESCRIPTION OF THE FIGURES

A better understanding of these and other embodiments can be obtained with reference to the following drawings and detailed description of the preferred embodiments, in which:

FIG. 1 shows a data processing system configured to determine discrepancies in databases;

FIG. 2 shows operations S200 of the data processing system (DPS) of FIG. 1;

FIG. 3 shows a query result received by the DPS of FIG. 1;

FIG. 4 shows another query result received by the DPS of FIG. 1; and

FIG. 5 shows an alternate query result received by the DPS 104 of FIG. 1.

Similar references are used in different figures to denote similar components.

### DETAILED DESCRIPTION

In the following description, reference is made to the accompanying drawings which form a part hereof and which illustrate the embodiments. It is understood that other embodiments may be utilized in which structural and operational changes may be made that are within the scope of the embodiments. The embodiments may be used to better understand performance discrepancies between DBMSs by comparing the Query Responses (QRs) generated by the DBMSs. The QRs may be generated by different DBMSs, such as for example, DB2™ Universal Database™ Version 8.1, DB2™ Universal Database™ Version 7.1, or ORACLE™9i.

In preferred embodiments, CRC (Cyclic Redundancy Check) and Checksum (CS) algorithms may be used during the process of ascertaining the discrepancies between DBMSs. It will be appreciated that other functionally equivalent algorithms may be used in place of the CRC algorithm and CS algorithms. The CRC algorithm generates a number which may be derived from a block of data (such as a row contained in a table, for example). The CRC algorithm may be used to detect data corruption, and CRC values are dependent on data values and ordering of data. The CS algorithm generates a value that depends on the contents of a block of data (such as for example, the data contained in a column of a table) in order to detect corruption of the data. CS values may be dependent upon data but not necessarily dependent on the order of the data.

The QRs may be generated by different DBMSs in response to the different DBMSs executing database queries (DQs), for example, complex read-only SQL statements, against their respective databases (DBs). A transforming algorithm may be applied on the data contained in the QRs. Examples of the transforming algorithm are the CRC algorithm (or similar) and/or the CS algorithm (or similar).

Some embodiments provide a method that allows data contained in the QRs to be compared by comparing CRC values and CS values instead of comparing the data contained in the QRs. Discrepancies that are found between QRs may be analyzed at a //record level. Other embodiments compare QRs by using an algorithm so that a single value may be produced for each QR being compared. This single value may be used to determine that QRs are essentially equivalent. Other embodiments manage records contained the QRs even though the order of the records in each QR do not match each other, but may be considered equivalent.

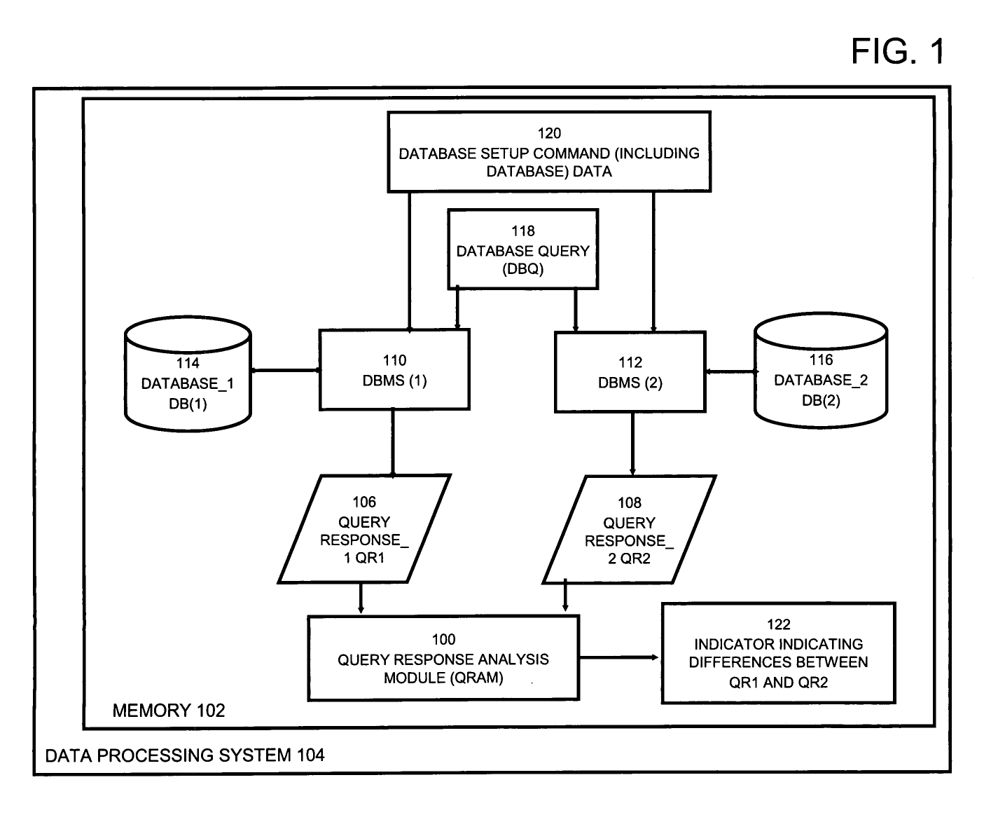

FIG. 1 shows a data processing system (DPS) 104 having a query response analysis module (QRAM) 100. The QRAM 100 is installed in a memory 102 associated with the DPS 104. The DPS 104 may be a single computer having various types or memory devices or may be a plurality of networked computers each having their own memory. The embodiment may be installed on a single DPS or installed on a plurality of network connected DPSs. The embodiment described here is implemented on a single DPS for ease of explanation. The QRAM 100 is a software-implemented tool for determining discrepancies between DBMSs.

Also stored in the memory 102 is a Query Response_1 (QR1) 106 and a Query Response_2 (QR2) 108. The QRAM 100 will read the QR1 106 and the QR2 108, analyze the contents thereof, and then generate an indicator 122. The indicator 122 is used to indicate discrepancies between the QR1 106 and the QR2 108.

Also stored in the memory 102 is a DBMS(1) 110 and a DBMS(2) 112. The DBMS(1) 110 may be a different version of the DBMS(2) 112, or the DBMS(1) 110 and the DBMS(2) 112 may be manufactured by different vendors. The DBMS(1) 110 generated the QR1 106, while the DBMS(2) 112 generated the QR1 108.

Also stored in the memory 102 is a database set-up command 120. The command 120 may include database data. The command 120 is executed against the DBMS(1) 110, and in response the DBMS(1) 110 generates a Database_1 DB(1) 114. In a similar way, the command 120 (or functional equivalent thereof) is executed against the DBMS(2) 112, and in response the DBMS(2) 112 generates a Database_2 DB(2) 116. It is understood that in an embodiment, generating the database includes populating the generated database with data (that is, populating the tables in the database with data). It will be appreciated that the command 120 may be tailored or adjusted so that DBMS(1) 110 and the DBMS(2) 112 may be able to successfully execute the command 120 and generate the DB(1) 114 and the DB(2) 116.

Also stored in the memory 102 is a database query (DBQ) 118. The DBQ 118 is executed by the DBMS(1) 110 against the DB(1) 114 and as a result, the QR1 106 may be generated. In a similar way, the DBQ 118 (or a functional equivalent thereof) is executed by the DBMS(2) 112 against the DB(2) 116 and as a result, the QR2 108 may be generated. It will be appreciated that the DBQ 118 may be tailored or adjusted so that DBMS(1) 110 and the DBMS(2) 112 may be able to successfully execute the DBQ 118 and thereby generate the QR1 106 and the QR2 108.

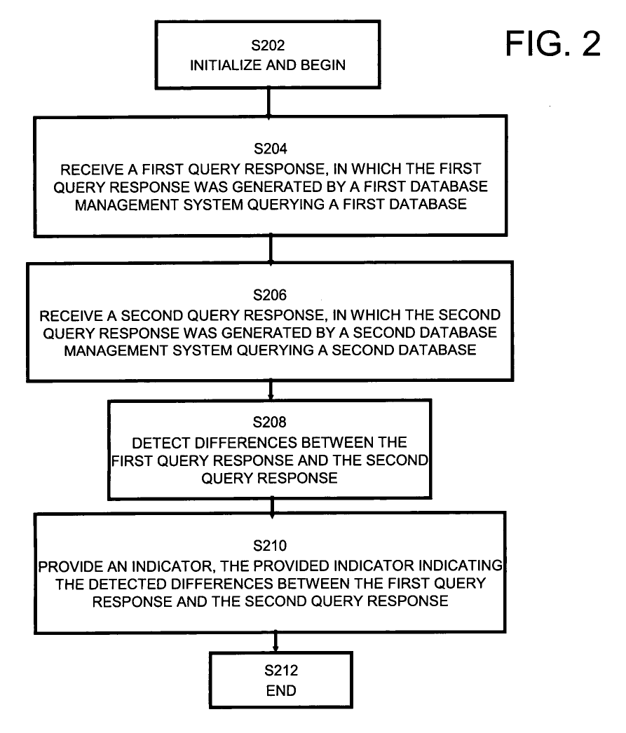

FIG. 2 shows operations S200 of the DPS 104 of FIG. 1. The operations S200 is a data processing system implemented method of directing the DPS 104 to determine discrepancies between a first DBMS and a second DBMS. The first DBMS populates a first database and the second DBMS populates a second database.

In operation S202, the DPS 104 initializes itself in preparation of executing the operations S200. In operation S204, the DPS 104 receives a first QR. The received first QR was generated by the first DBMS querying the first database. In operation S206, the DPS 104 receives a second QR. The received second QR was generated by the second DBMS querying the second database.

In operation S208, the DPS 104 determines discrepancies between the received first QR and the received second QR. In operation S210, the DPS 104 provides an indicator. The provided indicator indicates the detected discrepancies between the received first QR and the received second QR.

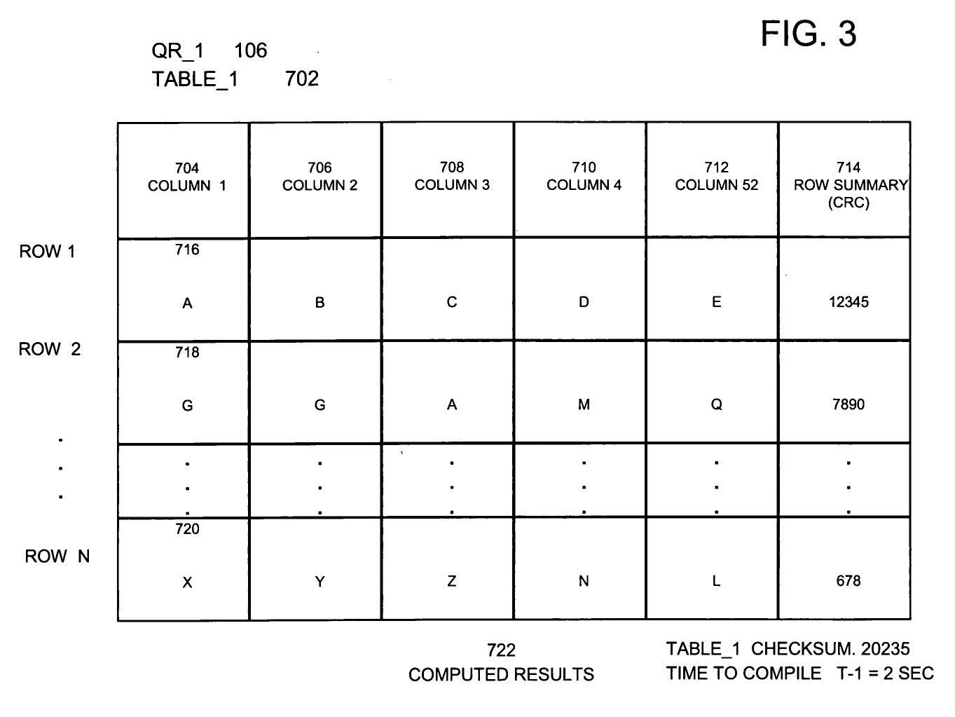

FIG. 3 shows a query result (QR_1) received, during operation S204, by the DPS 104 of FIG. 1 with the addition of a CRC computation for each row, and a final CS. The CRC and CS may be computed in operation S208 in order to detect differences.

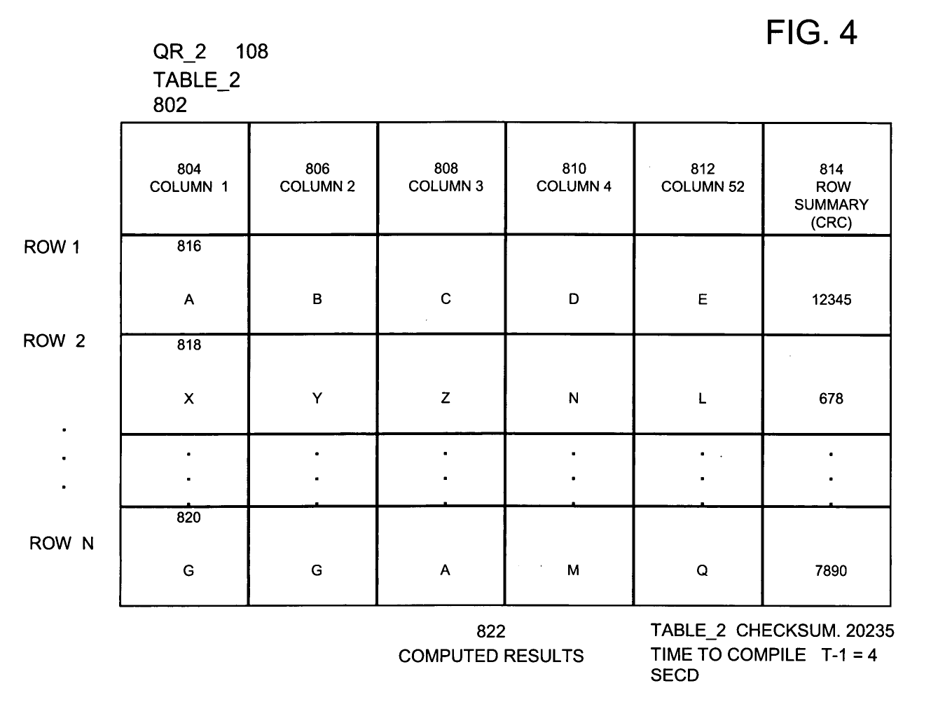

FIG. 4 shows a query result (QR_2) received, during operation S206, by the DPS 104 of FIG. 1 with the addition of a CRC computation for each row, and a final CS. The CRC and CS may be computed in operation S208 in order to detect differences.

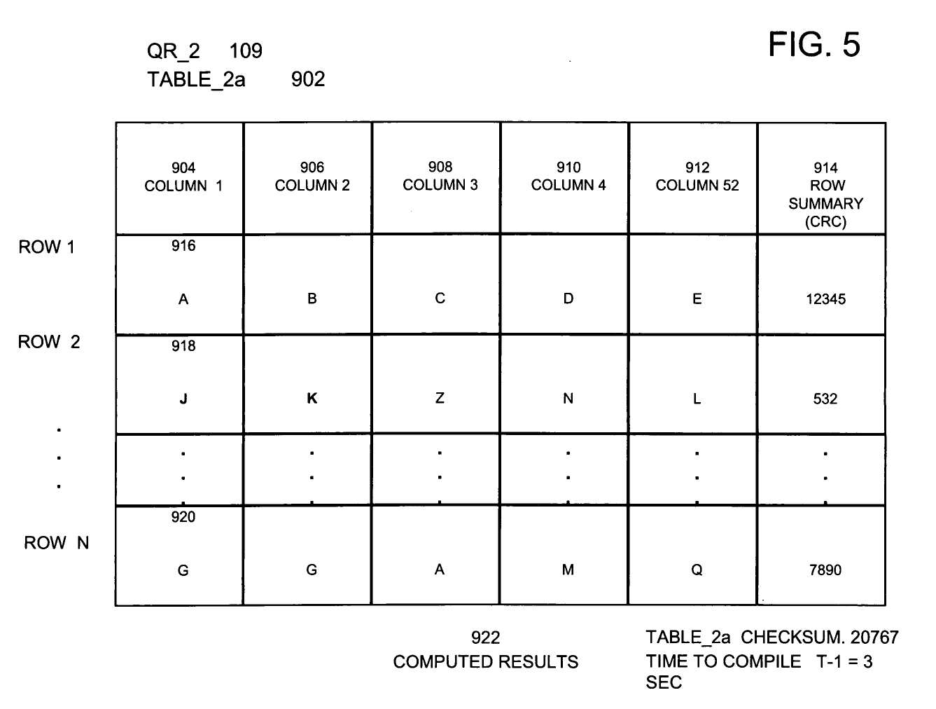

FIG. 5 shows an alternate query result received by the DPS 104 of FIG. 1, such as for example, the alternate query may have been returned during operation S206 by DBMS2.

In operation S208, the CSs may be compared to see if they match. If they do match, no further analysis is required and the method indicator may indicate that there are no detected discrepancies (such as in operation S210). It should be noted that the CSs match even though Row 2 and Row N are reversed in FIG. 4 since this is an order-independent computation. However, had the CSs not matched, which is the case with FIG. 5, operation S208 may investigate further by comparing the CRC computations for each row. Operation S208 may detect, for example Row 2 from FIG. 3 and Row 2 from FIG. 5, do not match each other. And in response, operation S210 may then provide an indicator indicating this discrepancy between the two results.

Further analysis in operation S208 may have been performed in the case of FIG. 3 and FIG. 5 whereby the rows that do not match may be further compared by looking at the column values, to determine which column(s) did not match. Thus operation S210 would further clarify that Column 1 and Column 2 do not match.

Contemplated Variations

The embodiment may be used to verify the content of datasources is the same. The embodiment may be used for testing purposes after the datasources have been initially prepared with equivalent data structure and data content, in which case this preliminary verification may ensure the datasources are equivalent before testing may begin.

The embodiment may be used for concurrency testing. Having the embodiment execute more than one instruction (such as a SELECT query for example) at a time may be used for testing concurrency. For datasources in which order of instruction processing is not guaranteed, the embodiment may execute instructions that do not affect the state of the data or structure.

The embodiment may be used with two or more datasources. These datasources may be able to communicate with the same programming language, or may use a third-party to convert from one programming language to another. An example of this is a federated system, where each datasource to compare for discrepancies is referred to as a target system, and the target systems are linked to the federated system. It is the job of the federated system to execute instructions on behalf of the embodiment on each target system, translating as required.

If using the embodiment for testing purposes, the attributes of datasources may vary in the area(s) the test is focused, creating a potential for results returned to be different for one or more datasources. For example, for DBMSs, variances such as different database brands, query optimization levels, parallelism, the way in which the structure and/or data were prepared, and the like, may be potentially good candidates. Assuming the DPSs (hardware and/or operating system) on which any datasource is run, is not a source of discrepancy for the results, any discrepancies may generally be caused by the datasource, which may include the user settings of the datasource.

The embodiment may be used to check for discrepancies when using datasource replication. A datasource's data may be replicated to one or more datasources. The embodiment may be used to check for discrepancies caused by replication.

The embodiment may be implemented such that the results returned from datasources executing the embodiments instructions may be compared through the use of CRC algorithms and CS algorithms. Data from each resulting record of information is transformed into a CRC value (which is stored for later comparison if necessary). All the CRC values for one result are transformed into one CS value. This single CS value is all that is needed to compare the results from different datasources. If this value doesn't match, then a comparison of each of the CRC values is done until the offending records are found. These are the records that have one or more discrepancies.

In the event one or more datasources are not successful at returning a result, the embodiment may determine if this may be due to an unexpected error or a known (ignorable) reason. In any case, the embodiment may stop executing the instruction(s) on other datasources. In the latter case, the embodiment may move on to the next set of instructions. In the former case, the embodiment may stop executing completely and report its findings.

It should be noted all actions the embodiment performs and the results generated may be logged which may make diagnosing discrepancies somewhat easier.

If all datasources successfully execute the instruction(s), the embodiment may proceed with prepping the results for comparison. A preliminary check may be made to ensure all results have returned the same number and types of fields. If this check fails, the embodiment may record this and proceed to the next set of instructions. A preliminary check of the number of records returned in each result may be used to indicate there may be a discrepancy in the results before data comparison actually occurs.

To actually compare each field of each record directly for two or more datasources may likely consume far too many resources. This is especially true if the result is composed of thousands or millions of records and/or each record is very large in size. This is one reason why using the CRC algorithm and CS algorithm may be used.

Each record may be represented by a single CRC value. CRC values are dependent upon data and order. The embodiment may fetch one record at a time from the result. When the record is retrieved, it may read the fields sequentially. Each field may be transformed into a basic data type that the CRC algorithm may understand. Generally this may be an array of bytes. The transformed data for each field may be the input into the CRC algorithm to generate a single value. This single value and a record identifier may be all that is stored about the record. The record identifier may allow the embodiment to jump back to that record for further analysis later if necessary. Once done with the record, the embodiment may move to the next record and repeat the process until the records from the result are exhausted.

Along with calculating a CRC value, a CS value may be calculated for the whole result. The CS value may take the CRC value from each record as input. A CS may be data-dependent but independent of order. Being order-independent may be required as it is quite possible that results from one datasource may not be in the same order as another but may still be equivalent.

Once the result for each datasource is processed, the embodiment may begin its comparison. A simple example of the way the results are compared assumes the first datasource always has the “correct” result. Thus each CS result may be compared only to the first datasource CS. If the CSs are the same, then the results may be considered equivalent and the embodiment may move on to execute another set of instructions and may repeat the whole process.

If the CSs do not match, then the embodiment may perform further analysis to determine where the discrepancy occurred. Since the invention has the CRC values for each record, it may compare for example, the first datasource CRC values with the datasource that has the CS mismatch. Since order is not guaranteed, discrepancies may be found through a process of elimination of all CRC values that are found in both results. The CRC values that remain may be referred to as orphans. The embodiment may fetch each record from their identifiers and dump the corresponding fields for further manual analysis.

If the discrepancy was not expected (which generally should be the case) the embodiment may stop processing instructions. If the CS values were all the same, it may move on to the next instruction and repeat the process.

It should be noted that this sort of validation checking may not necessarily guarantee the results are correct, but may ensure the results are the same amongst datasources. When proper variances are used between datasources like different brands (different source code), the chances of discovering a discrepancy may be increased.

Along with validation and integrity checking, additional modules may be added to the embodiment such as a performance analyzer. Since the embodiment may execute the same instruction(s) on several datasources, the time required to execute the statement may be recorded and compared. The embodiment may react to large discrepancies in time for example, or may leave it as an analysis task outside the scope of the embodiment.

Certain data types may not be compared byte-for-byte, as they can actually vary slightly and may still be considered equivalent. This may be the case for floating point fields. There may actually be fractional discrepancies between the values. These discrepancies are generally compared to a certain tolerance. If it does not exceed this tolerance, then the values are considered essentially equal. If the embodiment does not actually compare the values for these floating point fields directly, such tolerance checking may be difficult. A way around this is to remove a portion of the fractional component that can deviate when comparing datasources and use the remaining as input into the CRC algorithm.

The embodiment's approach to validation is relative to the datasources. So there may be no guarantee that the results are actually correct. The embodiment's purpose is to point out discrepancies when comparing two or more datasources. It is preferred that the prime datasource used is reliable, accurate, and trusted.

### Glossary

A datasource may be a location of media and the protocol and software used to deliver the media. Examples are: DBMS and database, flat file management system and flat file, spreadsheet management system and spreadsheet.

A record in a database (also called a row) may be a record that holds all the information about one item or subject. Examples are: contact information, item for sale, etc.

A field (also called a column) is an area of a database record, into which a particular item of data is stored. Examples are: telephone number, contact first name, etc.

An instruction is one or more commands issued to a datasource that produce a result. An example may be an SQL SELECT statement issued to a database can return zero or more records as a result.

CRC is an acronym for cyclic redundancy check. A CRC number is a number derived from a block of data in order to detect corruption. CRC values are dependent on data and ordering of this data.

CS is an acronym for checksum. A CS is a computed value that depends on the contents of a block of data in order to detect corruption of the data. CS values in the context of this invention are dependent upon data but not the order of the logical chunks of data.

The detailed description of the embodiments does not limit the implementation to any particular computer programming language. The computer program product may be implemented in any computer programming language provided that the OS (Operating System) provides the facilities that may support the requirements of the computer program product. Any limitations presented would be a result of a particular type of operating system, computer programming language, or DPS and would not be a limitation of the embodiments described herein.

It will be appreciated that the elements described above may be adapted for specific conditions or functions. The concepts of embodiments may be further extended to a variety of other applications that are clearly within the scope of this invention. Having thus described the embodiments as implemented, it will be apparent to those skilled in the art that many modifications and enhancements are possible to the embodiments without departing from the basic concepts as described. Therefore, the present invention is intended to be protected by way of letters patent should be limited only by the scope of the following claims.

What is claimed is:

1. A data processing system implemented method of directing a data processing system to determine discrepancies between a first database management system and a second database management system, the first database management system populating a first database and the second database management system populating a second database, the data processing system implemented method comprising:
receiving a first query response, the received first query response generated by the first database management system querying the first database;
receiving a second query response, the received second query response generated by the second database management system querying the second database;
detecting discrepancies between the received first query response and the received second query response; and
providing an indicator, the provided indicator indicating the detected discrepancies.

2. The data processing system implemented method of claim 1 wherein:
the first database management system receives a first database set-up command, the first database set-up command directing the first database management system to populate the first database;
the second database management system receives a second database set-up command, the second database set-up command directing the second database management system to populate the second database; and
execution of the first database set-up command and execution of the second database set-up command result in populating the first database and the second database with equivalent objects.

3. The data processing system implemented method of claim 2 wherein:
the first database management system generates the first query response by executing a first query against the first database;
the second database management system generates the second query response by executing a second query against the second database; and
the first query is equivalent to the second query.

4. The data processing system implemented method of claim 1 wherein:
the first query response comprises a first table having a first table row; and
the second query response comprises a second table having a second table row.

5. The data processing system implemented method of claim 4 further comprising:
identifying any rows of the first table rows which are different from any rows of the second table.

6. The data processing system implemented method of claim 4 further comprising:
associating a first identifier with the first table row;
associating a second identifier with the second table row; and
determining whether the first table row is different from the second table row based upon the associated first identifier and the associated second identifier.

7. The data processing system implemented method of claim 6 further comprising:
basing the associated first identifier and the associated second identifier on a CRC computation.

8. The data processing system implemented method of claim 6 further comprising:
associating first identifiers with respective table rows of the first table;
associating a first consolidated identifier with the associated first identifiers;
associating second identifiers with respective table rows of the second table;
associating a second consolidated identifier with the associated second identifiers; and
determining whether the first table is different from the second table based on a comparison between the associated first consolidated identifier and the associated second consolidated identifier.

9. The data processing system implemented method of claim 8 further comprising:
basing the associated first consolidated identifier and the associated second consolidated identifier on an order-independent computation.

10. The data processing system implemented method of claim 1 further comprising:
determining a time comparison between the time taken to generate the first query response and the time taken to generate the second query response.

11. The data processing system implemented method of claim 1 further comprising:
rounding off data contained in the first query response and contained in the second query response before detecting any discrepancies between the first query response and the second query response.

12. A data processing system for determining discrepancies between a first database management system and a second database management system, the first database management system populating a first database and the second database management system populating a second database, the data processing system comprising:
a receiving module for receiving a first query response, the received first query response generated by the first database management system querying the first database;
a receiving module for receiving a second query response, the received second query response generated by the second database management system querying the second database;
a detecting module for detecting discrepancies between the first query response and the second query response; and
a providing module for providing an indicator, the provided indicator indicating the detected discrepancies.

13. The data processing system of claim 12 wherein:
the first database management system receives a first database set-up command, the first database set-up command directing the first database management system to populate the first database;
the second database management system receives a second database set-up command, the second database set-up command directing the second database management system to populate the second database; and
execution of the first database set-up command and execution of the second database set-up command result in populating the first database and the second database with equivalent objects.

14. The data processing system of claim 13 wherein:
the first database management system generates the first query response by executing a first query against the first database;
the second database management system generates the second query response by executing a second query against the second database; and
the first query is equivalent to the second query.

15. The data processing system of claim 12 wherein:
the first query response comprises a first table having a first table row; and
the second query response comprises a second table having a second table row.

16. The data processing system of claim 15 further comprising:
an identifying module for identifying any rows of the first table rows which are different from any rows of the second table.

17. The data processing system of claim 15 further comprising:
an associating module for associating a first identifier with the first table row;
an associating module for associating a second identifier with the second table row; and
a determining module for determining whether the first table row is different from the second table row based upon the associated first identifier and the associated second identifier.

18. The data processing system of claim 17 further comprising:
a basing module for basing the associated first identifier and the associated second identifier on a CRC computation.

19. The data processing system of claim 17 further comprising:
an associating module for associating first identifiers with respective table rows of the first table;
an associating module for associating a first consolidated identifier with the associated first identifiers;
an associating module for associating second identifiers with respective table rows of the second table;
an associating module for associating a second consolidated identifier with the associated second identifiers; and
a determining module for determining whether the first table is different from the second table based on a comparison between the associated first consolidated identifier and the associated second consolidated identifier.

20. The data processing system of claim 19 further comprising:
a basing module for basing the associated first consolidated identifier and the associated second consolidated identifier on an order-independent computation.

21. The data processing system of claim 12 further comprising: a determining module for determining a time comparison between the time taken to generate the first query response and the time taken to generate the second query response.

22. The data processing system of claim 12 further comprising:
a rounding module for rounding off data contained in the first query response and contained in the second query response before detecting any discrepancies between the first query response and the second query response.

23. An article of manufacture for directing a data processing system to determine discrepancies between a first database management system and a second database management system, the first database management system populating a first database and the second database management system populating a second database, the article of manufacture comprising:

24. A program usable medium embodying one or more instructions executable by the data processing system, the one or more instructions comprising:
data processing system executable instructions for receiving a first query response, the received first query response generated by the first database management system querying the first database;
data processing system executable instructions for receiving a second query response, the received second query response generated by the second database management system querying the second database;
data processing system executable instructions for detecting discrepancies between the received first query response and the received second query response; and
data processing system executable instructions for providing an indicator, the provided indicator indicating the detected discrepancies.

25. The article of manufacture of claim 24 wherein:
the first database management system receives a first database set-up command, the first database set-up command directing the first database management system to populate the first database;
the second database management system receives a second database set-up command, the second database set-up command directing the second database management system to populate the second database; and
execution of the first database set-up command and execution of the second database set-up command result in populating the first database and the second database with similar objects.

26. The article of manufacture of claim 25 wherein:
the first database management system generates the first query response by executing a first query against the first database;
the second database management system generates the second query response by executing a second query against the second database; and
the first query is equivalent to the second query.

27. The article of manufacture of claim 24 wherein:
the first query response comprises a first table having a first table row; and
the second query response comprises a second table having a second table row.

28. The article of manufacture of claim 27 further comprising:
data processing system executable instructions for identifying any rows of the first table rows which are different from any rows of the second table.

29. The article of manufacture of claim 27 further comprising:
data processing system executable instructions for associating a first identifier with the first table row;
data processing system executable instructions for associating a second identifier with the second table row; and
data processing system executable instructions for determining whether the first table row is different from the second table row based upon the associated first identifier and the associated second identifier.

30. The article of manufacture of claim 29 further comprising:
data processing system executable instructions for basing the associated first identifier and the associated second identifier on a CRC computation.

31. The article of manufacture of claim 29 further comprising:
data processing system executable instructions for associating first identifiers with respective table rows of the first table;
data processing system executable instructions for associating a first consolidated identifier with the associated first identifiers;
data processing system executable instructions for associating second identifiers with respective table rows of the second table;
data processing system executable instructions for associating a second consolidated identifier with the associated second identifiers; and
data processing system executable instructions for determining whether the first table is different from the second table based on a comparison between the associated first consolidated identifier and the associated second consolidated identifier.

32. The article of manufacture of claim 31 further comprising:
data processing system executable instructions for basing the associated first consolidated identifier and the associated second consolidated identifier on an order-independent computation.

33. The article of manufacture of claim 24 further comprising:
data processing system executable instructions for determining a time comparison between the time taken to generate the first query response and the time taken to generate the second query response.

34. The article of manufacture of claim 24 further comprising:
data processing system executable instructions for rounding off data contained in the first query response and contained in the second query response before detecting any discrepancies between the first query response and the second query response.
